(19) United States
(12) Patent Application Publication
(10) Pub. No.: US 2020/0134480 A1
(43) Pub. Date: Apr. 30, 2020

(54) APPARATUS AND METHOD FOR DETECTING IMPACT FACTOR FOR AN OPERATING ENVIRONMENT

(71) Applicant: Institute For Information Industry, Taipei (TW)

(72) Inventors: Huan-Chi PENG, New Taipei City (TW); Yu-Xuan SU, New Taipei City (TW); Yin-Jing TIEN, Taipei City (TW); Yi-Hsin WU, New Taipei City (TW); Cheng-Juei YU, New Taipei City (TW)

(21) Appl. No.: 16/205,218

(22) Filed: Nov. 29, 2018

(30) Foreign Application Priority Data
Oct. 26, 2018 (TW) 107138000

(51) Int. Cl. G06N 5/02; G06N 20/00; G06F 16/2455

(52) U.S. Cl. CPC G06N 5/022; G06F 16/24558; G06N 20/00

(57) ABSTRACT

An apparatus and method for detecting impact factors for an operating environment. The apparatus generates a detection result for each of the first factors of a plurality of first historical records by analyzing a dissimilarity degree of the plurality of first data corresponding to each first factor. Each detection result is a continuous data type or a discrete data type. The apparatus trains a data type recognition model according to the first historical records and the detection results. The apparatus establishes a basic prediction model by a training set of a plurality of second historical records, generates a comparison set by rearranging the second data corresponding to a specific factor in the training set, establishes a comparison prediction model by the comparison set, and determines a degree of importance of the specific factor by comparing the accuracies of the basic prediction model and the comparison prediction model.

### PRIORITY

This application claims priority to Taiwan Patent Application No. 107138000 filed on Oct. 26, 2018, which is hereby incorporated by reference in its entirety.

### FIELD

The present invention relates to an apparatus and a method for detecting impact factors for an operating environment. More specifically, the present invention relates to an apparatus and a method for detecting data types and degrees of importance of impact factors for an operating environment.

### BACKGROUND

In order to improve various performances (e.g., yield, power consumption) of an operating environment (e.g., a production line, a smart building), managers need to know the crucial impact factors (e.g., temperature, humidity, machine number, or the like) of the operating environment. Before analyzing which factors are the crucial impact factors of an operating environment, managers must know the data type of each of the factors. In other words, the manager must know whether each factor corresponds to a continuous data type (i.e., the magnitudes of the data values are meaningful, e.g., the production rate, yield, time, temperature, or the like) or a discrete data type (i.e., the magnitudes of the data values are meaningless, e.g., the machine number, gender, or the like).

According to the current practice in the art, the field formats of a database have to be pre-defined by a professional that has great knowledge of various kinds of data and then the data type of a factor can be determined by comparing whether the data of the factor conforms to any of the pre-defined field format. However, with the rapid development of science and technology, an operating environment is influenced by more and more factors and the data formats corresponding to the factors are diverse and become more and more complicated. If one still adopts the current practice in the art (i.e. pre-defining field formats and then comparing the formats), it is not only time-consuming but also inaccurate. Therefore, applying the current practice to the modern operating environment is infeasible. Moreover, there are interactions between factors, which makes it even harder to correctly and effectively determine the crucial impact factors among the factors of an operating environment (particularly when the number of the factors become larger).

Accordingly, there is an urgent need in the art for a technique that can effectively determine the data type of massive data of an operating environment (i.e., determine whether the data is a continuous data type or a discrete data type) and then accurately determine the degrees of importance of the factors of the operating environment and thereby determine which factors are the crucial impact factors.

### SUMMARY

Provided are an apparatus and a method for detecting impact factors for an operating environment. The apparatus for detecting impact factors for an operating environment c an comprise a storage and a processor, wherein the storage is electrically connected to the processor. The storage is configured to store a plurality of first historical records and store a plurality of second historical records of the operating environment, each of the first historical records comprises a plurality of first data which correspond to a plurality of first factors in one-to-one correspondence, and each of the second historical records comprises a plurality of second data which correspond to a plurality of second factors in one-to-one correspondence. The processor is configured to generate an detection result for each of the first factors by analyzing a dissimilarity degree of the first data corresponding to each of the first factors, wherein each of the detection results is one of a continuous data type and a discrete data type. The processor trains a data type recognition model according to the first historical records and the detection results.

Moreover, the processor determines a data type of each of the second factors by using the data type recognition model to analyze the second data corresponding to each of the second factors and establishes a basic prediction model by a first subset of the second historical records and the data types. The processor generates a comparison set by rearranging the second data corresponding to a specific factor in the first subset and establishes a comparison prediction model by the comparison set and the data types. The processor obtains a basic accuracy by using a second subset of the second historical records to test the basic prediction model, obtains another accuracy by using the second subset to test the comparison prediction model, and determines a degree of importance of the specific factor by comparing the basic accuracy with another accuracy.

The method for detecting impact factors for an operating environment is adapted for use in an electronic apparatus. The electronic apparatus stores a plurality of first historical records and stores a plurality of second historical records of the operating environment, each of the first historical records comprises a plurality of first data which correspond to a plurality of first factors in one-to-one correspondence, and each of the second historical records comprises a plurality of second data which correspond to a plurality of second factors in one-to-one correspondence. The method can comprise the steps: (a) generating an detection result for each of the first factors by analyzing a first dissimilarity degree of the first data corresponding to each of the first factors, wherein each of the first detection results is one of a continuous data type and a discrete data type, (b) training a data type recognition model according to the first historical records and the detection results, (c) determining a data type of each of the second factors by using the data type recognition model to analyze the second data corresponding to each of the second factors, (d) establishing a basic prediction model by a first subset of the second historical records and the data types, (e) generating a comparison set by rearranging the second data corresponding to a specific factor in the first subset, (f) establishing a comparison prediction model by the comparison set and the data types, (g) obtaining a basic accuracy by using a second subset of the second historical records to test the basic prediction model, (h) obtaining another accuracy by using the second subset to test the comparison prediction model, and (i) determining a degree of importance of the specific factor by comparing the basic accuracy with the another accuracy.

A plurality of first historical records can be used to establish a data type recognition model and then uses the data type recognition model and a plurality of second historical records of an operating environment to detect the impact factors of the operating environment. Generally speaking, the present invention uses the data type recognition model to determine a data type of each of the second factors of the second historical records, uses a first subset of the second historical records to establish a basic prediction model, generates one or more comparison sets by rearranging the second data corresponding to one or more specific factors in the first subset, and then establishes one or more comparison prediction models. Thereafter, the present invention uses a second subset of the second historical records to test the basic prediction model and the one or more comparison prediction models and then determines the degree of importance of each of the one or more specific factors according to the test results. In this way, which specific factor(s) is/are more important can be further determined.

The detection technology can automatically, effectively, and accurately determine whether the data type is a continuous data type or a discrete data type and thereby prevent the cost and inaccuracy caused by the need of pre-defining the field formats of data by people. Moreover, the present invention may establish a plurality of prediction models according to a plurality of historical data of an operating environment, test the accuracy of each of the prediction models, and calculate the degree of importance of the specific factor and thereby find out the crucial impact factors of the operating environment. The detection technology provided by the present invention can avoid the high cost and the low accuracy caused by excessive factors in an operating environment.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view depicting a detection apparatus 1 according to a first embodiment of the present invention;

FIG. 1B illustrates a specific example of a first historical record according to the present invention;

FIG. 1C depicts four detection results of each of the first factors in a specific example;

FIG. 1D illustrates a specific example of second historical records according to the present invention;

FIG. 1E illustrates a specific example of a first comparison set according to the present invention;

FIG. 1F illustrates a specific example of a second comparison set according to the present invention;

FIG. 2A is a flowchart depicting a second embodiment of the present invention; and

FIG. 2B is a flowchart depicting some embodiments of the present invention.

### DETAILED DESCRIPTION

In the following description, an apparatus and a method for detecting impact factors for an operating environment will be explained with reference to certain example embodiments thereof. However, these example embodiments are not intended to limit the present invention to any specific example, embodiment, environment, applications, or implementations described in these example embodiments. Therefore, description of these example embodiments is only for purpose of illustration rather than to limit the scope of the present invention.

It shall be appreciated that, in the following embodiments and the attached drawings, elements unrelated to the present invention are omitted from depiction; and dimensions of and dimensional relationships among individual elements in the attached drawings are provided only for illustration, but not to limit the scope of the present invention.

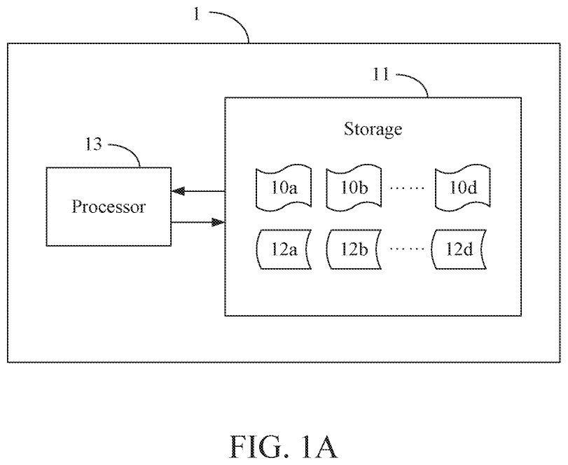

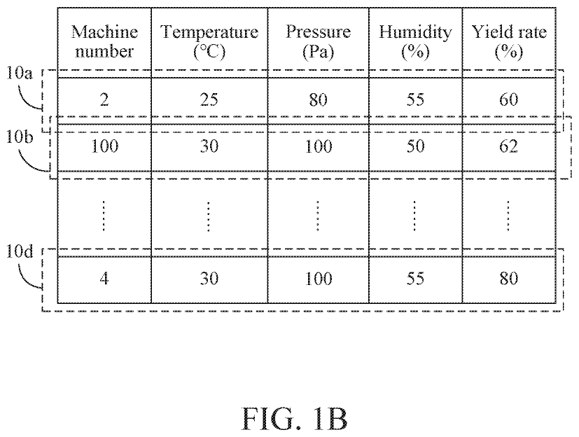

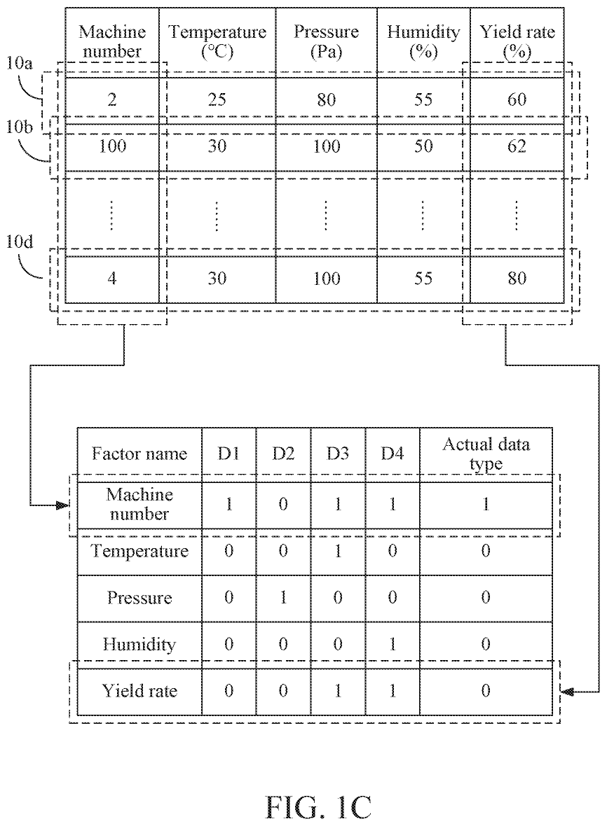

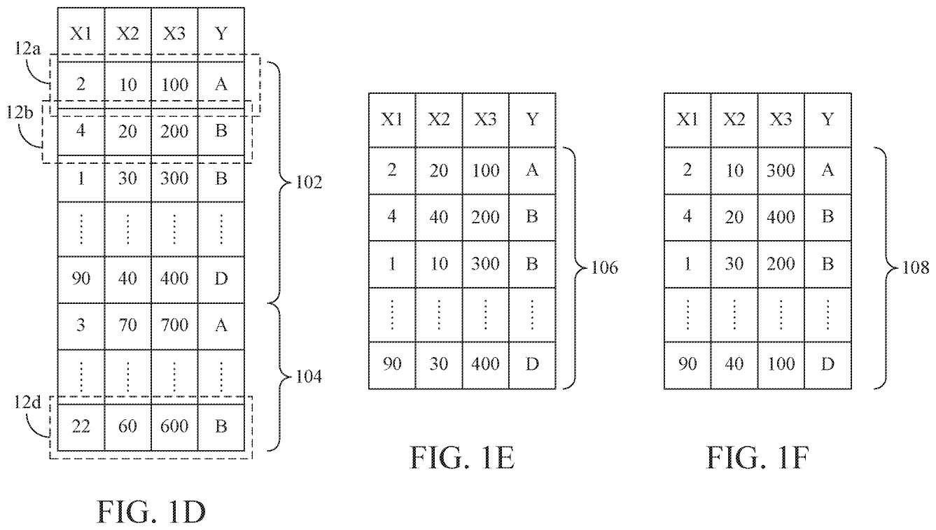

A first embodiment of the present invention is an apparatus for detecting impact factors for an operating environment (hereinafter referred to as “detection apparatus 1”), whose schematic view is depicted in FIG. 1. The detection apparatus 1 comprises a storage 11 and a processor 13, wherein the storage 11 is electrically connected with the processor 13. The storage 11 may be one of a memory, a universal serial bus (USB), a hard disk, a compact disk (CD), a mobile disk, or any other storage media or circuits with the same function and well known to those of ordinary skill in the art. The processor 13 may be one of various processing units, central processing units (CPU), digital signal processors (DSP), microprocessors, or other computing apparatuses well known to those of ordinary skill in the art.

In this embodiment, the storage 11 of the detection apparatus 1 stores a plurality of first historical records 10a, 10b, . . . , 10d, and each of the first historical records 10a, 10b, . . . , 10d comprises a plurality of first data which correspond to a plurality of first factors in one-to-one correspondence. For comprehension, please refer to a specific example shown in FIG. 1B. This specific example will be used in the subsequent description. It is noted that descriptions related to this specific example is not intended to limit the scope of the present invention. In this specific example, each of the first historical records 10a, 10b, . . . , 10d comprises five first data which correspond to five first factors (i.e., the machine number, temperature, humidity, pressure, and yield rate) one-to-one. It shall be appreciated that the first historical records 10a, 10b, . . . , 10d may be records generated by any operating environment during previous operation(s). The present invention does not limit the way to obtain the first historical records 10a, 10b, . . . , 10d and the way to obtain the first historical records 10a, 10b, . . . , 10d is not the focus of the present invention, so the details will not be described herein.

The storage 11 further stores a plurality of second historical records 12a, 12b, . . . , 12d, and each of the second historical records 12a, 12b, . . . , 12d comprises a plurality of second data which correspond to a plurality of second factors one-to-one. It shall be appreciated that the second historical records 12a, 12b, . . . , 12d come from an operating environment (e.g., a production line, a smart building) whose factors is going to be examined in terms of degree of importance. Please note that the number and types of the second data and the second factors are not limited in the present invention. Moreover, the second historical records 12a, 12b, . . . , 12d and the first historical records 10a, 10b, . . . , 10d may be from different operating environments.

The operations executed by the detection apparatus 1 may be divided into two stages. The operations of the first stage utilize the first historical records 10a, 10b, . . . , 10d to establish a data type recognition model, while the operations of the second stage detect the degrees of importance of the factors of the operating environment according to the second historical records 12a, 12b, . . . , 12d. Thereby, which factors are the crucial impact factors can be further determined.

Hereinafter, how the detection apparatus 1 uses the first historical records 10a, 10b, . . . , 10d to establish a data type recognition model will be described. Generally speaking, the detection apparatus 1 of the present invention may adopt four detection technologies to individually examine the data type of each of the first factors and then use the first historical records 10a, 10b, . . . , 10d and the detection results of the four detection technologies to train a data type recognition model. The four detection technologies used by the detection apparatus 1 will be detailed in the following descriptions. Please refer to FIG. 1C together, which illustrates the actual data type of each of the first factors and the detection results of the four detection technologies on each of the first factors.

The first detection technology examines the percentage of distinct values of the first data for each of the first factors. Specifically, the processor 13 generates a first detection result D1 for each of the first factors by analyzing a first dissimilarity degree of the first data corresponding to each of the first factors. It shall be appreciated that each of the first detection results D1 is the data type (i.e., the continuous data type or the discrete data type) of the corresponding first factor. Please note that the continuous data type refers to data of which the magnitudes of values are meaningful (e.g., the time, temperature, size, or the like) and the discrete data type refers to data of which the magnitudes of the values are meaningless (e.g., the machine number and the gender of personnel, or the like).

Taking the first factor “machine number” as an example, the processor 13 analyzes the dissimilarity degree of the corresponding first data (i.e., 2, 100, . . . , 4) and thereby generate the first detection result D1 (i.e., the discrete data type, which is represented by the digit “1”) of the first factor “machine number.” Taking the first factor “temperature” as another example, the processor 13 analyzes the dissimilarity degree of the corresponding first data (i.e., 25, 30, . . . , 30) and thereby generate the first detection result D1 (i.e., the continuous data type, which is represented by the digit “0”) of the first factor “temperature.” Furthermore, taking the first factor “yield rate” as another example, the processor 13 analyzes the dissimilarity degree of the corresponding first data (i.e., 60, 62, . . . , 80) and thereby generate the first detection result D1 (i.e., the continuous data type, which is represented by the digit “0”) of the first factor “yield rate.”

Regarding the first detection technology, in some embodiments, the processor 13 generates the first detection result D1 corresponding to each of the first factors by performing the following operations on each of the first factors: generating a first comparison result by comparing a mode count of the first data corresponding to the first factor with a first threshold, generating a second comparison result by comparing a distinct count of the first data corresponding to the first factor, and deciding the first detection result D1 according to the first comparison result and the second comparison result. For example, the processor 13 may obtain a first comparison result and a second comparison result of each of the first factors according to the following equations (1) and (2) respectively. Please note that the following equations are not intended to limit the scope of the present invention:

$$\begin{matrix}Len ( Mode ( X ) ) \geq {T}_{1} & ( 1 ) \\ \frac{Len ( Distinct ( X ) )}{N} \leq {T}_{2} & ( 2 )\end{matrix}$$

In the aforesaid equations (1) and (2), the parameter X represents the first data corresponding to a first factor, the parameter N represents the count of the first data corresponding to the first factor, Mode(X) represents the mode of the first data corresponding to the first factor, Len(Mode(X)) represents the count of the aforesaid mode, the parameter T₁ represents a first threshold

$$( e . g . , \frac{N}{3} ,$$

but not limited thereto), the parameter Distinct(X) represents the distinct values among the first data corresponding to the first factor, the parameter Len(Distinct(X)) represents the distinct count, and the parameter T₂ represents a second threshold (e.g., 0.2, but not limited thereto).

The processor 13 determines whether the mode count of the first data corresponding to a first factor is higher than the first threshold (i.e., whether the equation (1) is satisfied), which is the first comparison result. Additionally, the processor 13 determines whether a distinct count of the first data corresponding to a first factor is lower than the second threshold (i.e., whether the equation (2) is satisfied), which is the second comparison result. If the first comparison result of the first factor is that the equation (1) is not satisfied and the second comparison result of the first factor is that the equation (2) is not satisfied, the processor 13 determines that the first detection result D1 of the first factor is a continuous data type. If the first comparison result and the second comparison result of the first factor show that at least one of the equations (1) and (2) is satisfied, the processor 13 determines that the first detection result D1 of the first factor is a discrete data type.

The second detection technology examines whether the first data corresponding to each of the first factors satisfies normal distribution. Specifically, the processor 13 generates a second detection result D2 for each of the first factors by comparing the first data corresponding to each of the first factors with a normal distribution model (i.e., for of the first factors, determining whether the corresponding first data satisfies normal distribution). Each of the second detection results D2 is the data type of the corresponding first factor (i.e., the continuous data type or the discrete data type). If the first data corresponding to a first factor satisfies a normal distribution model (i.e., satisfies normal distribution), the processor 13 determines that the second detection result D2 of the first factor is the continuous data type (which is represented by the digit “0” in FIG. 1C). If the first data corresponding to a first factor does not satisfy a normal distribution model (i.e., does not satisfy the normal distribution), the processor 13 determines that the second detection result D2 of the first factor is the discrete type data (which is represented by the digit “1” in FIG. 1C).

The third detection technology examines a discontinuity of the first data corresponding to each of the first factors. Specifically, the processor 13 generates a third detection result D3 for each of the first factors by analyzing a discontinuity of the first data corresponding to each of the first factors by a LabelEncoder. Each of the third detection results D3 is the data type of the corresponding first factor (i.e., the continuous data type or the discrete data type). If the processor 13 determines, via the LabelEncoder, that the first data corresponding to a first factor has discontinuous values, the third detection result D3 of the first factor is the continuous data type (which is represented by the digit “0” in FIG. 1C). If the processor 13 determines, via the LabelEncoder, that the first data corresponding to a first factor is continuous without discontinuity, the third detection result D3 of the first factor is the discrete data type (which is represented by the digit “1” in FIG. 1C). It shall be appreciated that the operations performed by the LabelEncoder shall be well known by those of ordinary skill in the art, so the details are not given herein.

The fourth detection technology examines the diversity of the groups formed by the first data corresponding to each of the first factors. Specifically, the processor 13 generates a fourth detection result D4 for each of the first factors by performing the following operations on each of the first factors: dividing the first data corresponding to the first factor into a plurality of data groups (e.g., by adopting a density-based spatial clustering of applications with noise (DBSCAN), but it is not limited thereto), calculating a measure of central tendency (e.g., a median) of each of the data groups, calculating a second dissimilarity degree among the measures of central tendency (e.g., by adopting the Kruskal-Wallis test, but it is not limited thereto), and deciding the fourth detection result D4 according to the second dissimilarity degree. Each of the fourth detection results D4 is the data type of the corresponding first factor (i.e., the continuous data type or the discrete data type). If the second dissimilarity degree corresponding to a first factor is that the dissimilarity of the measures of central tendency is not obvious, the processor 13 determines that the fourth detection result D4 of the first factor is the continuous data type (which is represented by the digit “0” in FIG. 1C). If the second dissimilarity degree corresponding to a first factor is that the dissimilarity of the measures of central tendency is obvious, the processor 13 determines that the fourth detection result D4 of the first factor is the discrete data type (which is represented by the digit “1” in FIG. 1C). It shall be appreciated that the operations performed by the DBSCAN and the Kruskal-Wallis test shall be well known by those of ordinary skill in the art, so the details are not given herein.

In this embodiment, the processor 13 of the detection apparatus 1 adopts the first detection technology. In other embodiments, the processor 13 of the detection apparatus 1 may adopt the first detection technology along with any combination of the second to fourth detection technologies, e.g., the first and the second detection technologies, the first and the third detection technologies, the first and the fourth detection technologies, the first to the fourth detection technologies, which will not be listed exhaustively herein.

Next, the processor 13 trains a data type recognition model (not shown) according to the first historical records 10a, 10b, . . . , 10d and the aforesaid detection results. In this embodiment, the processor 13 adopts the first detection technology and, hence, the processor 13 trains the data type recognition model according to the first historical records 10a, 10b, . . . , 10d and the first detection results Dl. In other embodiments, the processor 13 may adopt the first detection technology along with any combination of the second to fourth detection technologies, so the processor 13 trains the data type recognition model according to the first historical records 10a, 10b, . . . , 10d, the first detection results D1, and the detection results of other adopted detection technologies.

For example, if the processor 13 adopts the first and second detection technologies, the processor 13 trains the data type recognition model according to the first historical records 10a, 10b, . . . , 10d, the first detection results Dl, and the second detection results D2. As another example, if the processor 13 adopts the first to the fourth detecting technologies, the processor 13 trains the data type recognition model according to the first historical records 10a, 10b, . . . , 10d, the first detection results D1, the second detection results D2, the third detection results D3, and the fourth detection results D4. According to the above descriptions, which detection results will be adopted along with the first historical records 10a, 10b, . . . , 10d to train the data type recognition model when the processor 13 adopts other combinations of the detection technologies shall be appreciated by those of ordinary skill in the art and, hence, the details will not be further described herein.

The data type recognition model trained by the processor 13 is a binary classification model that is capable of recognizing whether a plurality of inputted data is a continuous data type or a discrete data type, e.g., a Logistic regression model but it is not limited thereto. How to train the data type recognition model according to the first historical records 10a, 10b, . . . , 10d and the aforesaid detection results shall be well known by those of ordinary skill in the art. Thus, the details will not be described herein.

The operation of the detection apparatus 1 in the second stage, i.e., how the detection apparatus 1 uses the data type recognition model and the second historical records 12a, 12b, . . . , 12d of the operating environment to detect the degree of importance of the factors of the operating environment in order to determine which factors are the crucial impact factors, will be described now.

As described previously, each of the second historical records 12a, 12b, . . . , 12d comprises a plurality of second data which correspond to a plurality of second factors one-to-one. For comprehension, please refer to a specific example shown in FIG. 1D. This specific example will be used for the subsequent description but please note that this specific example is not intended to limit the scope of the present invention. In this specific example, each of the second historical records 12a, 12b, . . . , 12d comprises four second data which correspond to four second factors X1, X2, X3, and Y one-to-one. The processor 13 determines the data type of each of the second factors X1, X2, X3, and Y by utilizing the data type recognition model to analyze the second data corresponding to each of the second factors X1, X2, X3, and Y, wherein each of the data types is the continuous data type or the discrete data type.

In some embodiments, the data type recognition model trained by the processor 13 has a third threshold (i.e., a value of the highest accuracy of determining the data type). In these embodiments, the processor 13 determines the data type corresponding to each of the second factors X1, X2, X3, and Y by performing the following operations on each of the second factors X1, X2, X3, and Y: calculating a data type recognition value according to the data type recognition model and the second data corresponding to the second factor and determining the data type by comparing the data type recognition value with the third threshold. For example, if the data type recognition value of a certain second factor is greater than the third threshold, it can be determined that the certain second factor corresponds to the discrete data type. If the data type recognition value of a certain second factor is not greater than the third threshold, it can be determined that the certain second factor corresponds to the continuous data type.

In some embodiments, the processor 13 may further calculate a data type accuracy of each of the second factors X1, X2, X3, and Y according to the data type recognition value of each of the second factors X1, X2, X3, and Y and the third threshold. For example, the processor 13 may calculate a difference between the data type recognition value of each of the second factors X1, X2, X3, and Y and the third threshold and then calculate the data type accuracy according to the difference, wherein the second factor of a lower difference has a higher data type accuracy. It shall be appreciated that the data type accuracy of a second factor represents a degree of confidence that the processor 13 accurately determines the data type of the second factor. In order to improve the accuracy of the data type of the second factors X1, X2, X3, and Y, a user of the detection apparatus 1 may perform additional detection(s) on the data type of the second factor having a lower data type accuracy (e.g., which is lower than another threshold).

Furthermore, the processor 13 divides the second historical records 12a, 12b, . . . , 12d into a first subset 102 and a second subset 104. For example, the processor 13 may divide the second historical records 12a, 12b, . . . , 12d into a first subset 102 and a second subset 104 according to a preset proportion (e.g., 4:1). The processor 13 takes the first subset 102 as a training set and takes the second subset 104 as a test set.

The processor 13 uses the second historical records included in the first subset 102 and the data types of the second factors X1, X2, X3, and Y to establish a basic prediction model (not shown), e.g., a basic prediction model for predicting the value of the second factor Y. For example, the basic prediction model may be a random forest, a support vector machine (SVM), a neural network, a linear regression model, a generalized linear model, but it is not limited thereto. The details in establishing the aforesaid model shall be well known by those of ordinary skill in the art, so the details will not be described herein.

Herein, it is assumed that the user wants to know the first degree of importance of a first specific factor (e.g., the second factor X2) in the second factors X1, X2, X3, and Y. The processor 13 generates a first comparison set 106 by rearranging (e.g., randomly changing the order of) the second data corresponding to the first specific factor (e.g., the second factor X2) in the first subset 102 as shown in FIG. 1E. The processor 13 then establishes a first comparison prediction model (not shown) by using the first comparison set 106 and the data types of the second factors X1, X2, X3, and Y. Similarly, the first comparison prediction model may be a random forest, a support vector machine (SVM), a neural network, a linear regression model, and a generalized linear model but it is not limited thereto. It shall be appreciated that the first comparison prediction model and the basic prediction model have to be the same type of prediction models.

After establishing the basic prediction model, the processor 13 obtains a basic accuracy by using the second historical records included in the second set 104 to test the basic prediction model. Similarly, after establishing the first comparison prediction model, the processor 13 obtains a first accuracy by using the second historical records included in the second subset 104 to test the first comparison prediction model. For example, if the data type of the second factor to be predicted is the continuous data type, the processor 13 may use the Pearson correlation coefficient to calculate the aforesaid basic accuracy and the first accuracy. If the data type of the second factor to be predicted is the discrete data type, the processor 13 may use the Chi-squared test to calculate the aforesaid basic accuracy and the first accuracy. It shall be appreciated that the aforesaid Pearson correlation coefficient and the Chi-squared test are only examples and shall not be used to limit the scope of the present invention.

Next, the processor 13 determines the first degree of importance of the first specific factor (e.g., the second factor X2) by comparing the basic accuracy and the first accuracy. For example, the processor 13 may decide the first degree of importance according to a difference between the basic accuracy and the first accuracy. The larger the difference between the basic accuracy and the first accuracy is, the larger the degree of the importance of the first specific factor will be (i.e., the first specific factor has a larger degree of influence on the operating environment).

In some embodiments, the processor 13 may test the degrees of importance of multiple specific factors among the second factors X1, X2, X3, and Y and then determine which factors are the crucial impact factors of the operating environment.

Specifically, the processor 13 may generate a second comparison set 108 by rearranging (e.g., randomly changing the order of) the second data corresponding to a second specific factor (e.g., the second factor X3) in the first subset 102 as shown in FIG. 1F. The processor 13 then establishes a second comparison prediction model (not shown) by using the second comparison set 108 and the data types of the second factors X1, X2, X3, and Y. Similarly, the second comparison prediction model may be a random forest, a support vector machine (SVM), a neural network, a linear regression model, and a generalized linear model but it is not limited thereto. It shall be appreciated that the basic prediction model, the first comparison prediction model, and the second comparison prediction model have to be the same type of prediction models.

After establishing the basic prediction model and the second comparison prediction model, the processor 13 obtains a second accuracy by using the second historical records included in the second set 104 to test the second comparison prediction model. The processor 13 then determines the second degree of importance of the second specific factor (e.g., the second factor X3) by comparing the basic accuracy and the second accuracy. For example, the processor 13 may decide the second degree of importance according to a difference between the basic accuracy and the second accuracy. The larger the difference between the basic accuracy and the second accuracy is, the larger the degree of importance of the second specific factor will be (i.e., the second specific factor has a larger degree of influence on the operating environment).

In some embodiments, the processor 13 may further determine which one of the first specific factor (e.g., the second factor X2) and the second specific factor (e.g., the second factor X3) has a higher degree of importance. For example, the processor 13 calculates a first absolute difference between the basic accuracy and the first accuracy, calculates a second absolute difference between the basic accuracy and the second accuracy, determines which one of the first absolute difference and the second absolute difference is greater, and determines that the degree of importance of the specific factor corresponding to the greater absolute difference is higher. In other words, if the first absolute difference is greater than the second absolute difference, the processor 13 considers that the first specific factor is more important than the second specific factor (i.e., the degree of influence of the first specific factor on the operating environment is larger than the degree of influence of the second specific factor on the operating environment).

Based on the aforesaid descriptions, how the processor 13 repeats the aforesaid operations to determine the degrees of importance of the reset specific factors and how the processor 13 determines which one of the specific factors is more important shall be appreciated by those of ordinary skill in the art. Thus, the details will not be repeated herein.

In some embodiments, the detection apparatus 1 may further comprise a display (not shown) and the display is electrically connected to the processor 13. In these embodiments, the display may display the second data corresponding to each of the second factors X1, X2, X3 and Y in a display mode (e.g., scatter diagram, boxplot, bar chart) corresponding to the data type of each of the second factors X1, X2, X3, and Y. For example, if the second factors X1, X2, X3, and Y are all of the continuous data type, the display may adopt a scatter diagram to display the second data corresponding to each of the second factors X1, X2, X3 and Y. If the second factors X1, X2, X3 and Y include the continuous data type and the discrete data type, the display may adopt a boxplot to display the second data corresponding to each of the second factors X1, X2, X3 and Y. If the second factors X1, X2, X3 and Y are all of the discrete data type, the display may adopt a bar chart to display the second data corresponding to each of the second factors X1, X2, X3 and Y.

According to the above descriptions, the detection apparatus 1 provides several ways to train a data type recognition model for automatically determining whether the data type corresponding to a factor is the continuous data type or the discrete data type. With the data type recognition model, the aforesaid comparison and analysis can be achieved without requiring the professionals to pre-define the formats. Therefore, the data type recognition model provided by the detection apparatus 1 can be applied to a complex operating environment (e.g., an operating environment that is influenced by an extremely large number of factors) and can effectively and accurately recognize the data type corresponding to a factor.

Moreover, the detection apparatus 1 examines the degrees of importance of the factors of an operating environment according to a plurality of historical records of the operating environment and thereby finds out which factors are the crucial impact factors. Briefly speaking, the detection apparatus 1 divides the historical records into a training set and a test set, rearranges the data corresponding to one or more specific factors in the training set to generate one or more comparison sets, and then uses the training set and the comparison set(s) to generate multiple prediction models. The detection apparatus 1 uses the test set to test the prediction models, determines the degree of importance of each specific factor according to the test result, and then determines which specific factor(s) is/are more important. Even if the operating environment is complex (e.g., an operating environment that is influenced by an extremely large number of factors) and the factors thereof interact with each other, the detection apparatus 1 can still effectively analyze the degrees of importance of the factors and determine the crucial impact factors.

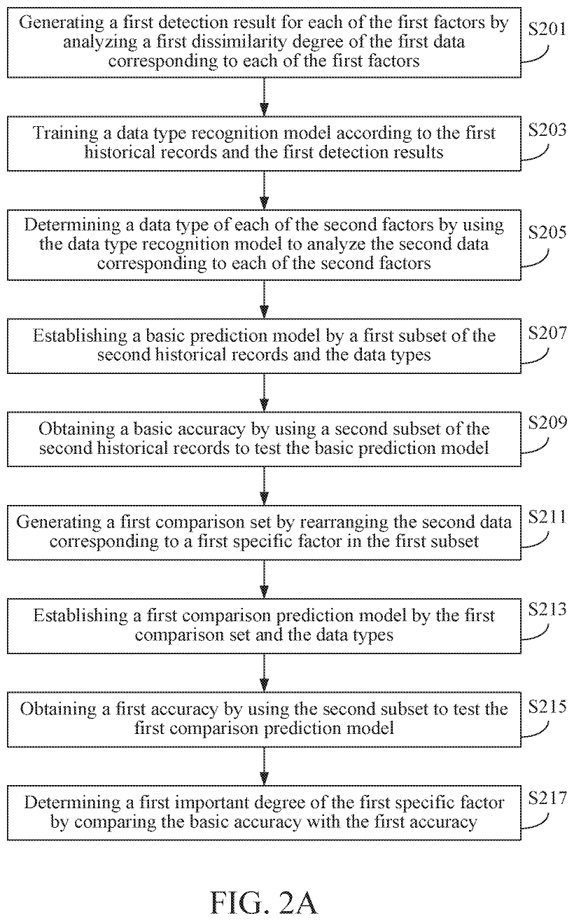

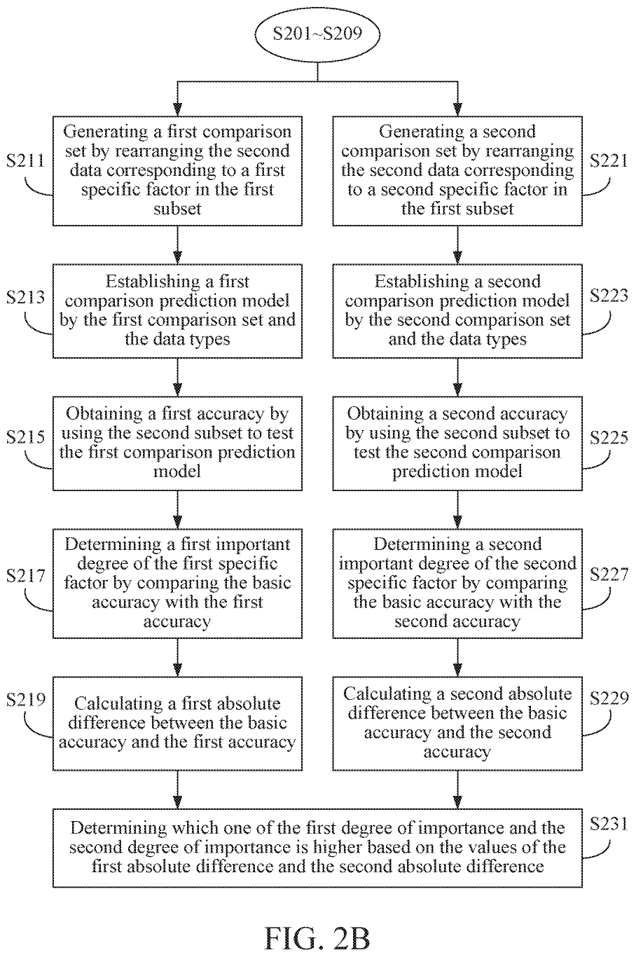

A second embodiment of the present invention is a method for detecting impact factors of an operating environment (hereinafter referred to as “detection method”) and a flowchart of which is depicted in FIG. 2A. The detection method is suitable for use in an electronic apparatus, e.g., the detection apparatus 1 described in the first embodiment.

In this embodiment, the electronic apparatus stores a plurality of first historical records (e.g., the first historical records 10a, 10b, . . . , 10d shown in FIG. 1A and FIG. 1B) and each of the first historical records comprises a plurality of first data which correspond to a plurality of first factors one-to-one. Moreover, the electronic apparatus stores a plurality of second historical records (e.g., the second historical records 12a, 12b, . . . , 12d shown in FIG. 1A and FIG. 1D) of the operating environment and each of the second historical records comprises a plurality of second data which correspond to a plurality of second factors one-to-one.

In step S201, the electronic apparatus generates a first detection result (e.g., the first detection result D1 of FIG. 1C) for each of the first factors by analyzing a first dissimilarity degree of the first data corresponding to each of the first factors, wherein the first detection result is one of a continuous data type and a discrete data type. Next, step S203 is executed by the electronic apparatus to train a data type recognition model according to the first historical records and the first detection results.

In some embodiments, the step S201 generates the first detection result corresponding to each of the first factors by performing the following operations on the first factor: generating a first comparison result by comparing a mode count of the first data corresponding to the first factor with a first threshold, generating a second comparison result by comparing a distinct count of the first data corresponding to the first factor with a second threshold, and deciding the first detection result according to the first comparison result and the second comparison result.

In some embodiments, the detection method further executes the following step before executing the step S203: generating, by the electronic apparatus, a second detection result (e.g., the second detection result D2 shown in FIG. 1C) for each of the first factors by comparing the first data corresponding to the first factor with a normal distribution model, wherein each of the second detection results is one of the continuous data type and the discrete data type. It shall be appreciated that, in these embodiments, the step S203 trains the data type recognition model according to the first historical records, the first detection results, and the second detection results.

In some embodiments, the detection method further executes the following step before executing the step S203: generating, by the electronic apparatus, a third detection result (e.g., the third detection result D3 shown in FIG. 1C) for each of the first factors by analyzing a discontinuity of the first data corresponding to each of the first factors by a LabelEncoder, wherein each of the third detection results is one of the continuous data type and the discrete data type. It shall be appreciated that, in these embodiments, the step S203 trains the data type recognition model according to the first historical records, the first detection results, and the third detection results.

In some embodiments, the detection method further generates a fourth detection result (e.g., the fourth detection result D4 shown in FIG. 1C) for each of the first factors by performing the following steps on each of the first factors before executing the step S203:

dividing the first data corresponding to the first factor into a plurality of data groups by the electronic apparatus, calculating a measure of central tendency of each of the data groups by the electronic apparatus, calculating a second dissimilarity degree among the measures of central tendency by the electronic apparatus, and deciding the fourth detection result according to the second dissimilarity degree by the electronic apparatus. Each of the fourth detection results is one of the continuous data type and the discrete data type. It shall be appreciated that, in these embodiments, the step S203 trains the data type recognition model according to the first historical records, the first detection results, and the fourth detection results.

In some embodiments, the detection method may adopt all of the aforesaid first to the fourth detection technologies to obtain the first detection results, the second detection results, the third detection results, and the fourth detection results. In these embodiments, the step S203 trains the data type recognition model by the electronic apparatus according to the first historical records, the first detection results, the second detection results, the third detection results, and the fourth detection results. It shall be appreciated that, in some embodiments, the detection method may adopt the aforesaid first detection technology along with any combination of the second to the fourth detection technologies. In these embodiments, the step S203 trains the data type recognition model by the electronic apparatus according to the first historical records and the detection results corresponding to the adopted detection technologies.

Thereafter, step S205 is executed by the electronic apparatus to determine a data type of each of the second factors by using the data type recognition model to analyze the second data corresponding to each of the second factors. In some embodiments, the data type recognition model further has a third threshold (i.e., a value of the highest accuracy of determining the data type). In these embodiments, the step S205 determines the data type corresponding to each of the second factors by performing the following operations on each of the second factors by the electronic apparatus: calculating the data type recognition value according to the data type recognition model and the second data corresponding to the second factor and determining the data type by comparing the data type recognition value with the third threshold. For example, if the data type recognition value is greater than the third threshold, it is determined that the second factor is the discrete data type. If the data type recognition value is not greater than the third threshold, it is determined that the second factor is the continuous data type. In these embodiments, the detection method may further comprise a step executed by the electronic apparatus for calculating a data type accuracy of each of the second factors according to the data type recognition value of each of the second factors and the third threshold. The data type accuracy of each of the second factors represents a degree of confidence that the detection method accurately determines the data type.

In step S207, the electronic apparatus establishes a basic prediction model by a first subset (e.g., the first subset 102 of FIG. 1D) of the second historical records and the data types of the second factors. In step S209, the electronic apparatus obtains a basic accuracy by using a second subset (e.g., the second subset 104 shown in FIG. 1) of the second historical records to test the basic prediction model. Additionally, in step S211, the electronic apparatus generates a first comparison set (e.g., the first comparison set 106 shown in FIG. 1E) by rearranging the second data corresponding to a first specific factor (the first specific factor is one of the second factors, e.g., the second factor X2 shown in FIG. 1D) in the first subset. In step S213, the electronic apparatus establishes a first comparison prediction model by the first comparison set and the data types of the second factors. In step S215, the electronic apparatus obtains a first accuracy by using the second subset to test the first comparison prediction model. Thereafter, in step S217, the electronic apparatus determines a first degree of importance of the first specific factor by comparing the basic accuracy with the first accuracy.

It shall be appreciated that the aforesaid steps S207 and S209 are related to the establishment and test of the basic prediction model, while the steps S211, S213, and S215 are related to the establishment and test of the first comparison prediction model. In some embodiments, the detection method may execute the steps S211 to S215 and then execute the steps S207 to S209. In some embodiments, the detection method may execute the steps relevant to the basic prediction model (i.e., the steps S207 to S209) and the steps relevant to the first comparison prediction model (i.e., the steps S211 to S215) in parallel. Based on the above descriptions, those of ordinary skill in the art shall appreciate that these steps can also be executed in other orders and the details will not be further described herein.

In some embodiments, the detection method may execute the flowchart as shown in FIG. 2B. In these embodiments, the detection method executes the steps S201 to S209 and then executes the steps S211 to S217. Thereafter, in step S219, the electronic apparatus calculates a first absolute difference between the basic accuracy and the first accuracy.

Additionally, after the step S209, the detection method further executes the steps S221 to S229. Specifically, in the step S221, the electronic apparatus generates a second comparison set (e.g., the second comparison set 108 shown in FIG. 1F) by rearranging the second data corresponding to a second specific factor (e.g., the second factor X3 shown in FIG. 1D) in the first subset. Next, in step S223, the electronic apparatus establishes a second comparison prediction model by the second comparison set and the data types of the second factors. In step S225, the electronic apparatus obtains a second accuracy by using the second subset to test the second comparison prediction model. In step S227, the electronic apparatus determines a second degree of importance of the second specific factor by comparing the basic accuracy with the second accuracy. Thereafter, in step S229, the electronic apparatus calculates a second absolute difference between the basic accuracy and the second accuracy. It shall be appreciated that, in some embodiments, the detection method may execute the steps S221 to S229 after executing the step S219.

In step S231, the electronic apparatus determines which one of the first degree of importance and the second degree of importance is higher based on the values of the first absolute difference and the second absolute difference. Specifically, if the step S231 determines that the first absolute difference is greater than the second absolute difference, the electronic apparatus considers that the first degree of importance is higher than the second degree of importance (i.e., the influence of the first specific factor on the operating environment is larger than the influence of the second specific factor on the operating environment) based on the determination result. On the contrary, if the step S231 determines that the second absolute difference is greater than the first absolute difference, the electronic apparatus considers that the second degree of importance is higher than the first degree of importance (i.e., the influence of the second specific factor on the operating environment is larger than the influence of the first specific factor on the operating environment) based on the determination result.

It shall be appreciated that the number of the specific factors selected by the detection method is not limited in the present invention. Therefore, the detection method may also select other specific factors from the second factors to generate other comparison prediction models, calculate the accuracy of other comparison prediction models, determines the degrees of importance of other specific factors, and overall determine whether the degrees of importance are high or low (i.e., overall determine whether the specific factors influence the operating environment to a higher or lower degree). For example, the detection method may treat each of the second factors as a specific factor and perform the aforesaid steps on the second factors one by one. The details will not be repeated herein.

In some embodiments, the detection method further enables the electronic apparatus to display the second data corresponding to each of the second factors in a displaying mode corresponding to the data types of the second factors. For example, if the second factors are all of the continuous data type, the second data may be displayed by a scatter diagram. If the second factors include the continuous data type and the discrete data type, the second data may be displayed by a boxplot. If the second factors are all of the discrete data type, the second data may be displayed by a bar chart.

In addition to the aforesaid steps, the second embodiment can execute all the operations and steps of the detection apparatus 1 set forth in the first embodiment, have the same functions, and deliver the same technical effects as the first embodiment. How the second embodiment executes these operations and steps, has the same functions, and delivers the same technical effects as the first embodiment will be readily appreciated by those of ordinary skill in the art based on the explanation of the first embodiment. Thus, the details will not be repeated herein.

It shall be appreciated that, in the specification and the claims of the present invention, some terms (including historical record, data, factor, specific factor, threshold, detection result, subset, comparison set, accuracy, degree of importance, and absolute difference) are preceded by the terms “first,” “second,” “third,” or “fourth” and these terms “first,” “second,” “third,” and “fourth” are used only for distinguishing different terms.

According to the above descriptions, the detection technology (at least comprising the apparatus and the method) according to the present invention may detect impact factors for an operating environment. The present invention uses one or more detection technologies to analyze whether each of the first factors of a plurality of first historical records is a continuous data type or a discrete data type and then trains a data type recognition model accordingly. With the data type recognition model, the present invention can effectively and accurately recognize the data type corresponding to a factor without requiring the professionals to pre-define the field formats and can be applied to a complex operating environment (e.g., an operating environment that is influenced by an extremely large number of factors).

The detection technology provided by the present invention may further detect the data type of each of the second factors of a plurality of second historical records of an operating environment (i.e., whether the data is the continuous data type or the discrete data type) by the data type recognition model and then use the data types of the second factors and a training set of the second historical records to establish the basic prediction model. Moreover, the detection technology of the present invention further generates one or more comparison prediction models by rearranging the second data corresponding to one or more specific factors in the training set. By calculating and comparing the accuracy of the basic prediction model and the one or more comparison prediction models, the present invention can find out the degree of importance of each of the specific factors and thereby determine which specific factor(s) is/are more important. Therefore, even if the operating environment is complex and the factors thereof interact with each other, the present invention can still effectively analyze the degrees of importance of the factors and find out the crucial impact factors.

The above disclosure is only utilized to enumerate partial embodiments of the present invention and illustrated technical features thereof, but not to limit the scope of the present invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for detecting impact factors for an operating environment, comprising:
a storage, being configured to store a plurality of first historical records and store a plurality of second historical records of the operating environment, each of the first historical records comprising a plurality of first data corresponding to a plurality of first factors one-to-one, and each of the second historical records comprising a plurality of second data corresponding to a plurality of second factors one-to-one; and
a processor electrically connected to the storage, being configured to generate a first detection result for each of the first factors by analyzing a first dissimilarity degree of the first data corresponding to each of the first factors, each of the first detection results being one of a continuous data type and a discrete data type,
wherein the processor further trains a data type recognition model according to the first historical records and the first detection results, determines a data type of each of the second factors by using the data type recognition model to analyze the second data corresponding to each of the second factors, establishes a basic prediction model by a first subset of the second historical records and the data types, generates a first comparison set by rearranging the second data corresponding to a first specific factor in the first subset, establishes a first comparison prediction model by the first comparison set and the data types, obtains a basic accuracy by using a second subset of the second historical records to test the basic prediction model, obtains a first accuracy by using the second subset to test the first comparison prediction model, and determines a first degree of importance of the first specific factor by comparing the basic accuracy with the first accuracy.

2. The apparatus of claim 1, wherein the processor generates the first detection result corresponding to each of the first factors by performing the following operations on each of the first factors:
generating a first comparison result by comparing a mode count of the first data corresponding to the first factor with a first threshold,
generating a second comparison result by comparing a distinct count of the first data corresponding to the first factor with a second threshold, and
deciding the first detection result according to the first comparison result and the second comparison result.

3. The apparatus of claim 1, wherein the processor further generates a second detection result for each of the first factors by comparing the first data corresponding to each of the first factor with a normal distribution model, each of the second detection results is one of the continuous data type and the discrete data type,
wherein the processor trains the data type recognition model according to the first historical records, the first detection results, and the second detection results.

4. The apparatus of claim 1, wherein the processor further generates a third detection result for each of the first factors by analyzing a discontinuity of the first data corresponding to each of the first factors by a LabelEncoder, each of the third detection results is one of the continuous data type and the discrete data type,
wherein the processor trains the data type recognition model according to the first historical records, the first detection results, and the third detection results.

5. The apparatus of claim 1, wherein the processor further generates a fourth detection result for each of the first factors by performing the following operations on each of the first factors:
dividing the first data corresponding to the first factor into a plurality of data groups,
calculating a measure of central tendency of each of the data groups,
calculating a second dissimilarity degree among the measures of central tendency, and
deciding the fourth detection result according to the second dissimilarity degree, wherein the fourth detection result is one of the continuous data type and the discrete data type,
wherein the processor trains the data type recognition model according to the first historical records, the first detection results, and the fourth detection results.

6. The apparatus of claim 1, wherein the data type recognition model has a threshold, and the processor determines the data type of each of the second factors by performing the following operations on each of the second factors:
calculating a data type recognition value by the data type recognition model and the second data corresponding to the second factor, and
determining the data type by comparing the data type recognition value with the threshold.

7. The apparatus of claim 6, wherein the processor further calculates a data type accuracy of each of the second factors according to the data type recognition value of each of the second factors and the threshold.

8. The apparatus of claim 1, wherein the processor further generates a second comparison set by rearranging the second data corresponding to a second specific factor in the first subset, establishes a second comparison prediction model by the second comparison set and the data types, obtains a second accuracy by using the second subset to test the second comparison prediction model, and determines a second degree of importance of the second specific factor by comparing the basic accuracy with the second accuracy.

9. The apparatus of claim 8, wherein the processor further calculates a first absolute difference between the basic accuracy and the first accuracy, calculates a second absolute difference between the basic accuracy and the second accuracy, determines that the first absolute difference is greater than the second absolute difference, and determines that the first degree of importance is higher than the second degree of importance according to the determination result that the first absolute difference is greater than the second absolute difference.

10. The apparatus of claim 1, further comprising:
a display electrically connected to the processor, being configured to display the second data corresponding to each of the second factors in a display mode corresponding to the data types of the second factors.

11. A method for detecting impact factors for an operating environment, being executed by an electronic apparatus, the electronic apparatus storing a plurality of first historical records and storing a plurality of second historical records of the operating environment, each of the first historical records comprising a plurality of first data corresponding to a plurality of first factors one-to-one, each of the second historical records comprising a plurality of second data corresponding to a plurality of second factors one-to-one, and the method comprising:
(a) generating a first detection result for each of the first factors by analyzing a first dissimilarity degree of the first data corresponding to each of the first factors, wherein each of the first detection results is one of a continuous data type and a discrete data type;
(b) training a data type recognition model according to the first historical records and the first detection results;
(c) determining a data type of each of the second factors by using the data type recognition model to analyze the second data corresponding to each of the second factors;
(d) establishing a basic prediction model by a first subset of the second historical records and the data types;
(e) generating a first comparison set by rearranging the second data corresponding to a first specific factor in the first subset;
(f) establishing a first comparison prediction model by the first comparison set and the data types;
(g) obtaining a basic accuracy by using a second subset of the second historical records to test the basic prediction model;
(h) obtaining a first accuracy by using the second subset to test the first comparison prediction model; and
(i) determining a first degree of importance of the first specific factor by comparing the basic accuracy with the first accuracy.

12. The method of claim 11, wherein the step (a) generates the first detection result corresponding to each of the first factors by performing the following operations on each of the first factors:
generating a first comparison result by comparing a mode count of the first data corresponding to the first factor with a first threshold;
generating a second comparison result by comparing a distinct count of the first data corresponding to the first factor with a second threshold; and
deciding the first detection result according to the first comparison result and the second comparison result.

13. The method of claim 11, further comprising:
generating a second detection result for each of the first factors by comparing the first data corresponding to each of the first factor with a normal distribution model, wherein each of the second detection results is one of the continuous data type and the discrete data type,
wherein the step (b) trains the data type recognition model according to the first historical records, the first detection results, and the second detection results.

14. The method of claim 11, further comprising:
generating a third detection result for each of the first factors by analyzing a discontinuity of the first data corresponding to each of the first factors by a LabelEncoder, wherein each of the third detection results is one of the continuous data type and the discrete data type,
wherein the step (b) trains the data type recognition model according to the first historical records, the first detection results, and the third detection results.

15. The method of claim 11, further comprising:
generating a fourth detection result for each of the first factors by performing the following steps on each of the first factors:
dividing the first data corresponding to the first factor into a plurality of data groups,
calculating a measure of central tendency of each of the data groups;
calculating a second dissimilarity degree among the measures of central tendency; and
deciding the fourth detection result according to the second dissimilarity degree, wherein the fourth detection result is one of the continuous data type and the discrete data type,
wherein the step (b) trains the data type recognition model according to the first historical records, the first detection results, and the fourth detection results.

16. The method of claim 11, wherein the step (c) determines the data type of each of the second factors by performing the following steps on each of the second factors:
calculating a data type recognition value by the data type recognition model and the second data corresponding to the second factor; and
determining the data type by comparing the data type recognition value with a threshold of the data type recognition model.

17. The method of claim 16, further comprising:
calculating a data type accuracy of each of the second factors according to the data type recognition value of each of the second factors and the threshold.

18. The method of claim 11, further comprising:
generating a second comparison set by rearranging the second data corresponding to a second specific factor in the first subset;
establishing a second comparison prediction model by the second comparison set and the data types;
obtaining a second accuracy by using the second subset to test the second comparison prediction model; and
determining a second degree of importance of the second specific factor by comparing the basic accuracy with the second accuracy.

19. The method of claim 18, further comprising:
calculating a first absolute difference between the basic accuracy and the first accuracy;
calculating a second absolute difference between the basic accuracy and the second accuracy;
determining that the first absolute difference is greater than the second absolute difference; and
determining that the first degree of importance is higher than the second degree of importance according to the determination result that the first absolute difference is greater than the second absolute difference.

20. The method of claim 11, further comprising:
displaying the second data corresponding to each of the second factors in a display mode corresponding to the data types of the second factors.
